(19) United States
(12) Patent Application Publication
(10) Pub. No.: US 2007/0117557 A1
(43) Pub. Date: May 24, 2007

(54) Parametric user profiling

(75) Inventors: Iqbal Adjali, Bedford (GB); Ogi Bataveljic, Bedford (GB); Marco De Boni, Bedford (GB); Malcolm Benjamin Dias, Bedford (GB); Robert Hurling, Bedford (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco Inc, d/b/a UNILEVER

(21) Appl. No.: 11/284,297

(22) Filed: Nov. 21, 2005

(51) Int. Cl. H04M 3/00

(52) U.S. Cl. 455/418

(57) ABSTRACT

An apparatus for behaviour monitoring on mobile computing devices and a method of operating such devices for adaptively profiling users and for optimising user profile storage requirements. The method comprising monitoring a behaviour of the user by interpreting one or more interactions between the device and the user and storing information relating to the behaviour of the user in at least a partially parameterised form. The method further comprising determining whether the user is exhibiting any changes in behaviour as a function of a variation in one or more parameters within the stored information.

### FIELD OF THE INVENTION

The present invention relates to behaviour monitoring and adaptive user profiling, and in particular relates to methods and apparatus for monitoring behavioural changes of users and optimising user profile storage requirements on mobile computing devices.

### BACKGROUND OF THE INVENTION

Various forms of interactive computing devices are known to exist in the prior art. Recently attempts have been made to make the interactive process or ‘dialogue’ more natural to the users of the computing devices, so that some form of adaptive feedback is provided. This is typically achieved by way of user profiling, where the computing device attempts to define a profile of the user by categorising their behaviour according to a number of predetermined criteria.

Such techniques have been found to be profitable in e-commerce and online retailing applications, as well as in other computing applications. However, as the current trend is towards mobile data communications, particularly with the advent of smart mobile phone technologies, there is an increasing demand to have profiling techniques implemented on mobile computing devices, such as mobile phones. A major problem with this however, is the generally limited processing power and storage capabilities of most mobile phones, which may suffer significant performance degradation when executing known adaptive profiling applications.

In the present invention an adaptive profiling apparatus is described that is able to define and store an optimised profile of a user in such a way that the storage demands on the mobile computing device are significantly reduced over conventional profiling techniques, while still providing a suitable definition of the user's activities to detect any changes in the user's behaviour.

An object of the present invention is to provide a mobile computing device that can adaptively profile a user and define the profile in an at least a partially parameterised form to optimise the storage requirements of the profile.

Another object of the present invention is to provide a profiling application that can define and optimise a user profile based on a behaviour of the user and can identify changes in the user's behaviour arising from variations in one or more profile parameters.

Another object of the present invention is to provide a profiling application that can define a user profile by way of one or more parametric tables comprising optimised parameters representative of the user's behaviour.

### DEFINITION OF THE INVENTION

According to an aspect of the present invention there is provided a method of operating a mobile computing device for interacting with a user and detecting changes in the behaviour of the user, comprising:
monitoring a behaviour of the user by interpreting one or more interactions between the device and the user;
storing information relating to the behaviour of the user in at least a partially parameterised form; and
determining whether the user is exhibiting any changes in behaviour as a function of a variation in one or more parameters within the stored information.

According to another aspect of the present invention there is provided an apparatus comprising:
a mobile computing device for interacting with a user and detecting changes in the behaviour of the user, including:
means for monitoring a behaviour of the user by interpreting one or more interactions between the device and the user;
means for storing information relating to the behaviour of the user in at least a partially parameterised form; and
means for determining whether the user is exhibiting any changes in behaviour as a function of a variation in one or more parameters within the stored information;
and
a remote gateway server for communicating with the mobile computing device, including a redundant temporal database comprising one or more parametric tables for receiving stored information from the mobile computing device.

According to another aspect of the present invention there is provided a mobile computing device for interacting with a user and for detecting changes in the behaviour of the user, comprising:
means for monitoring a behaviour of the user by interpreting one or more interactions between the device and the user;
means for storing information relating to the behaviour of the user in at least a partially parameterised form; and
means for determining whether the user is exhibiting any changes in behaviour as a function of a variation in one or more parameters within the stored information.

According to a further aspect of the present invention there is provided a remote gateway server for communicating with a mobile computing device, comprising:
means for receiving from the mobile computing device information relating to the behaviour of the user in at least a partially parameterised form; and
a redundant temporal database comprising one or more parametric tables for receiving the information from the mobile computing device.

### DETAILED DESCRIPTION OF THE INVENTION

Embodiments of the present invention will now be described in detail by way of example and with reference to the accompanying drawings in which:

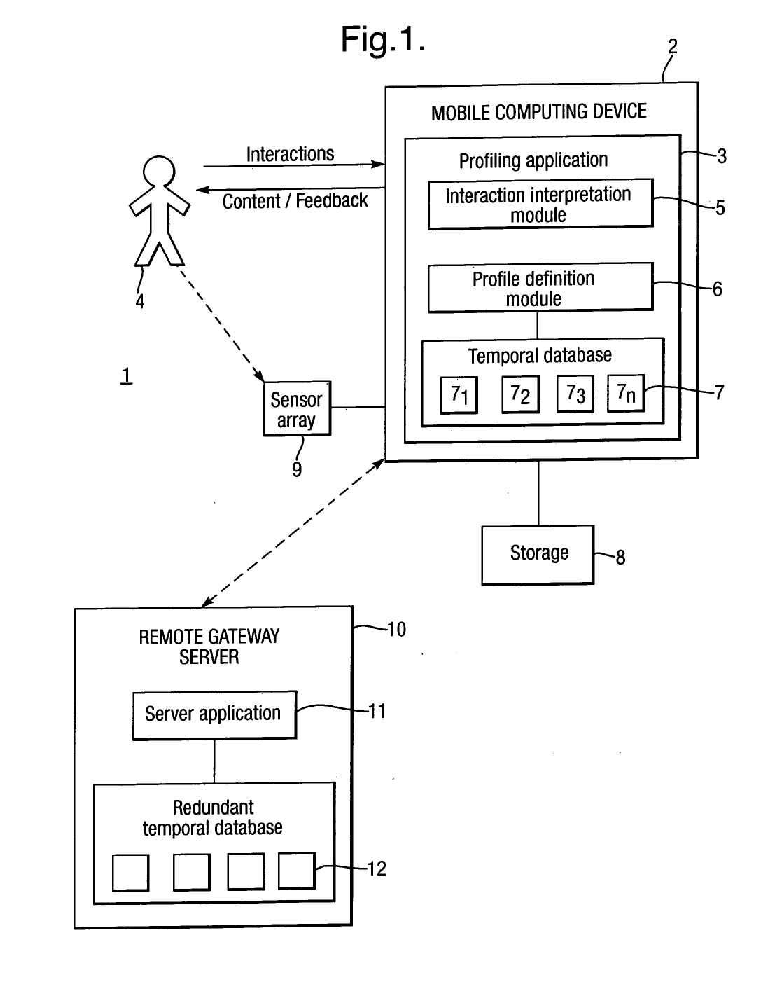

FIG. 1 is a schematic view of a particularly preferred arrangement of an adaptive profiling and profile optimisation apparatus according to the present invention, and

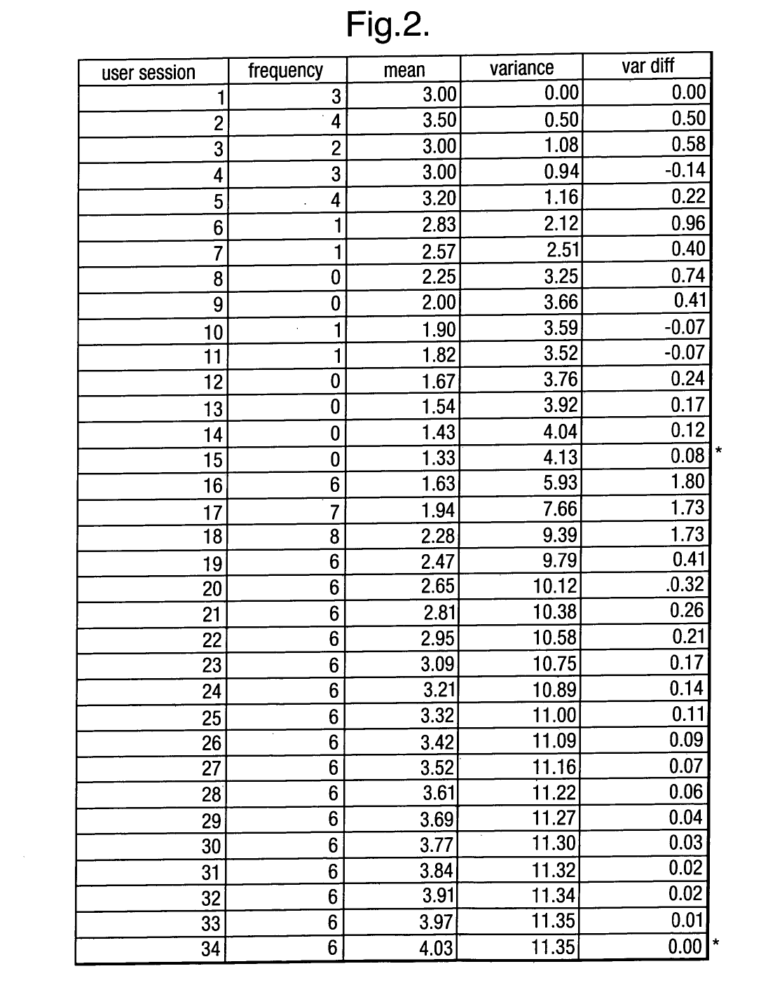

FIG. 2 is a table of statistical data relating to an example use of the apparatus of FIG. 1.

With reference to FIG. 1 there is shown a particularly preferred arrangement of an adaptive profiling and profile optimisation apparatus 1 (hereinafter referred to as the “apparatus”) according to the present invention. The apparatus 1 comprises a mobile computing device 2 (hereinafter referred to as the ‘mobile device’) of a kind that is capable of executing the profiling application 3 of the present invention.

In exemplary arrangements, the mobile device 2 is most preferably a WAP (Wireless Application Protocol) enabled mobile phone, but may also be any of the following devices: a laptop computer, a personal digital assistant (PDA) or a tablet PC, modified in accordance with the prescriptions of the following arrangements.

It is to be appreciated however, that the mobile device 2 may be any suitable portable data exchange device that is capable of interacting with a user 4, e.g. by providing information, content and/or feedback to the user 4 in some form.

Preferably, the profiling application 3 may be implemented using any suitable programming language, e.g. C, C++ or JavaScript etc. either as an application or applet, and is preferably platform/operating system independent, to thereby provide portability of the application to different mobile devices. In most preferred arrangements, it is intended that the profiling application 3 will be installed on the mobile device 2 by remotely accessing a suitable software repository (e.g. a remote server or on-line database etc.), and then downloading the application 3 to the device 2.

Alternatively, the profiling application 3 may be directly installed on the mobile device 2 by inserting a suitable media (e.g. CD-Rom, DVD, Compact Flash, Secure Digital card etc.) containing the application into the device 2.

In other arrangements, the profiling application 3 may be pre-installed in the mobile device 2 during manufacture, and would preferably reside on a ROM (read only memory) chip or other suitable non-volatile storage device 8 or integrated circuit.

In accordance with the present invention, the profiling application 3 is operable to monitor a behaviour of the user 4 of the mobile device 2 by interpreting one or more interactions between the device 2 and user 4, so as to define a profile for the user 4 which is comprised of a plurality of parameterised data relating to the user's behaviour. As the user's profile is parameterised the storage requirements of the profile are significantly reduced, which minimises the demands on the storage capacity of the mobile device 2, which is particularly advantageous in mobile phone applications, where the memory capacity may be relatively limited.

By ‘behaviour’ we mean any act or activity in which the user 4 is physically and/or consciously participating or interacting, and may also include any characteristic that the user 4 may be exhibiting towards any such act or activity and/or any physiological changes that arise form participating in such acts or activities. Preferred behaviours which are monitored by the apparatus of the present invention include physical exercise (e.g. jogging, aerobics etc.), shopping (either high street or on-line, number of items bought etc.), use of systems/software (e.g. what types of software are used and how this is used), web browsing/surfing and biometric evaluations of the user 4 (e.g. heart rate, blood pressure or chemical composition of blood/perspiration/urine etc., which may be linked to the exercise or shopping monitoring etc.).

References to an ‘interaction’ between the device 2 and user 4 are intended to mean any form of mutual or reciprocal action that involves an exchange or transfer of information or data in some form, with or without physical contact, and particularly relates to a mode of use of the device 2 by the user 4. For example, interactions include, but are not limited to, touching the device (e.g. holding, pressing, squeezing etc.), entering information into the device (e.g. by typing), issuing verbal commands/instructions to the device (e.g. via continuous speech or discrete keywords) and presentation of audio and/or visual content by the device (i.e. surfing/browsing and/or viewing content on the device). It is apparent therefore, that a mode of use of the device may thus involve any one or more of the foregoing examples, e.g. surfing the web, playing music or accessing regular news updates etc.

In preferred arrangements, the profiling application 3 comprises a number of different software modules or applets, including an ‘interaction interpretation module’ 5 (hereinafter referred to as the ‘interpretation module’) and a ‘profile definition module’ 6 (hereinafter referred to as the ‘definition module’).

The role of the interpretation module 5 is to monitor the behaviour or behaviours of the user 4 by interpreting the interactions between the mobile device 2 and the user 4. For example, if the user 4 is using the mobile device 2 to surf or browse the web via the Internet, then the interpretation module 5 will monitor the user's web usage by identifying which web sites, web pages and other URL resources are accessed, viewed and downloaded by the user 4. Preferably, the monitoring may also include determining how long the user 4 spends browsing a particular page or category of page, and how this relates to the overall time spent surfing and browsing the web etc.

In accordance with the present invention, the profiling application 3 is operable to adaptively profile the user 4 based on their monitored behaviours as interpreted by the interpretation module 5. However, unlike known profiling applications in other apparatus, it is not necessary for the present profiling application 3 to maintain a session log of the user's activities throughout the time spent interacting with the mobile device 2 in order to define a user profile. Instead, the definition module 6 defines the user profile by ‘encoding’ the user's behaviours in a parameterised data structure which includes a statistical representation of the user's past and present behaviours. The expression ‘parameterised data’ is intended to encompass data sets in which individual raw data values received, have been aggregated or accumulated to provide compound data values providing a representative measure of the individual raw data values from which they are derived.

In preferred arrangements, the data structure is in the form of a temporal database 7, which preferably forms part of the coding of the profiling application 3, but may alternatively be a separate construct that is linked to the application 3 during execution. Preferably, the temporal database 7 comprises one or more parametric tables 7₁ . . . 7ₙ which are structured to receive statistical parameters defining the user's behaviours.

Preferably, one of the tables 7₁ . . . 7ₙ is arranged to store statistical parameters relating to the user's current behaviours, and another table is arranged to store corresponding statistical parameters relating to the user's previous behaviours. Hence, in this way, the profiling application 3 can determine whether there has been any statistically significant change in any of the user's behaviours between when the previous values where calculated and the calculation of the current values.

Any suitable statistical parameter may be stored in the parametric tables 7₁ . . . 7ₙ, including, but not limited to, the current and previous values, means, variances, minimum and maximum values, and largest and smallest changes etc. Moreover, the statistical parameters may be instantaneous values, rolling values (e.g. value as ascertained over a fixed time interval), weighted values (e.g. a bias or weight is applied to the value, such as large values are given a large weight) and threshold values (e.g. can set a numerical level to which values are compared).

In particularly preferred arrangements, the temporal database 7 is configured to include 3 parametric tables—a previous session value table (e.g. to contain previous values), a mean value table (e.g. to contain the current mean values) and an instantaneous-variance measure table (e.g. to contain the instantaneous-variance of the corresponding entries in the mean table). The use of 3 tables is found to be optimum for minimising storage requirements on the mobile device 2, while still adequately providing an appropriate definition of the user's profile to enable a determination of behavioural change to be made.

However, it is to be appreciated that any number of parametric tables may be used in accordance with the present invention, depending upon which aspects of the user profile are desired to be defined and/or the particular application. Moreover, the tables 7₁ . . . 7ₙ may be ‘nested’, in that they may physically form part of the same table but each corresponds to a distinct, separately addressable portion of the table.

Preferably, each table 7₁ . . . 7ₙ is structured so as to have a plurality of ‘category columns’ each corresponding to one of the user's behaviours, e.g. exercise, shopping, software usage, web surfing and biometrics etc., with each category column being sub-divided into one or more ‘activity columns’. Hence, for example, in the case of a web surfing category column, this could be sub-divided into a plurality of activity columns, each corresponding to a predetermined web site (e.g. default ‘popular’ sites like microsoft.com, bbc.co.uk, mtv.com etc.) or a recently visited web site (as determined by the interpretation module 5). In a similar fashion, the biometrics category column could be sub-divided into ‘heart rate’, ‘blood pressure’ and ‘perspiration’ activity columns etc. and so on.

Hence, in arranging the parametric tables 7₁ . . . 7ₙ in this way, the user profile can advantageously be reduced to a structured framework or construct which allows statistical values representing a behaviour of the user 4 to be mapped to a corresponding category and/or activity column.

It is to be appreciated that the foregoing examples are not intended to be limiting, and therefore any suitable behaviour that is capable of being monitored by the apparatus of the present invention may be entered as a category column and further sub-divided as necessary. Moreover, the above table structure represents only a preferred arrangement, and therefore any suitable parametric table structure may be used in accordance with the principles of the present invention.

It is to be appreciated that the meaning of “table” is not intended to be limited to a 2-dimensional ‘grid structure’ of data, but instead is to be interpreted as a data structure or construct in which corresponding data items (e.g. parameters) can be conveniently stored, associated and cross-referenced, in any suitable form, and may for instance, reside within allocated memory address space with stored values being linked via pointers.

In preferred arrangements, during the first user session all entries in the respective parametric tables 7₁ . . . 7ₙ are preferably set to zero, to initialise the tables. Thereafter, the definition module 6 receives data from the interpretation module 5, and begins to populate the columns of the mean value table with numerical values associated with the user's behaviour, such as the frequency at which a user's heart rate increases above a certain level during exercise, or how often a user views a particular web site etc. Preferably, at the end of the user session, or at some other predetermined time (e.g. when the profiling application is ‘idling’, e.g. when there are no interactions with the user 4), the definition module 6 converts the numerical values obtained during the session into mean values for the respective behaviour, which for the first session will be equivalent to the actual value, as the number of user sessions will be ‘1’.

It is to be understood that by ‘user session’ we mean each time that the profiling application 3 is invoked and executed by the user 4 on the mobile device 2, with each session being validly counted if it comprises one or more interactions associated with one or more monitored behaviours.

Accordingly, following the calculation of the mean values, the entries in the mean value table are preferably copied to respective category and activity columns in the previous session value table, these values providing a convenient set of ‘initial’ values against which the values within the mean value table may be compared during subsequent user sessions.

Preferably, the number of user sessions on which the previous session value table entries are calculated is maintained and stored in the previous session value table, which comprises a specific column in the table for this purpose. The number of user sessions is a numerical positive integer value, which increases by ‘1’ with each user session.

At the start of each subsequent user session, the entries in the mean value table are re-set to the default value of zero. Thereafter, each time the user 4 interacts with the mobile device 2, the corresponding entries in the columns for that behaviour can be updated. In the example of the web browsing behaviour, each time the user 4 views a listed web site, the value in the corresponding activity column of the mean value table will be incremented by ‘1’. In this way, a running count is maintained of the viewing frequency of the web site during that particular session. At the end of the user session, or at some other predetermined time, the definition module 6 converts the respective viewing frequency counts into corresponding mean values, based on the previous mean value (as stored in the previous session value table), the viewing frequency counts for that session and the incremented total number of user sessions, and thereby replaces the entries in the mean value table with the newly calculated mean values.

Preferably, following the calculation of the mean values, the definition module 6 also proceeds to calculate for each mean value, an instantaneous-variance value which is then entered against the corresponding category and activity column within the instantaneous-variance measure table. The definition module 6 compares the newly calculated variance value to the previous variance value for that behaviour, and proceeds to calculate the difference between the two values. The resulting ‘residual variance’ provides a convenient numerical measure of the change in the user's behaviour towards that particular activity, as the residual variance will be close to zero if the user's behaviour is stable or unchanging, whereas conversely, if the user's behaviour suddenly changes, or becomes increasingly erratic, the residual variance will correspondingly rapidly diverge from zero (either positively or negatively). Hence, it is found that the faster the residual variance changes, the more pronounced is the user's corresponding behavioural change.

Hence, by way of illustration, FIG. 2 shows a table of statistical parameters related to an example behaviour of the user, e.g. the web browsing behaviour as previously discussed. FIG. 2 lists the results from monitoring 34 different user sessions (column 1) in which a particular activity has been monitored and a running count or frequency determined (column 2). Hence, for example, in relation to the web browsing behaviour, in user session 5, the user 4 has viewed a particular web site 4 times during that session. In columns 3 and 4 respectively, are listed the calculated mean and instantaneous-variance values for each user session, and in the final column there are listed the corresponding residual variance values as calculated for the respective user session. Therefore, for example, the residual variance for user session 20 is 0.32.

Referring to column 2 of FIG. 2, it can be observed that the user 4 views the particular web site, for instance, reasonably often during the first 5 user sessions, but then infrequently views the same site during sessions 6 to 15. In particular, the user 4 does not view the web site at all during user sessions 12 to 15, and therefore it can be seen that the residual variance correspondingly decreases towards zero, having a numerical value of 0.08 at the end of user session 15 (this is highlighted by the upper asterisk in FIG. 2). Important to note is the sudden behaviour change of the user 4 during user session 16, in which the previously infrequently viewed web site is now viewed 6 times during that session. As a result, the residual variance diverges rapidly away from zero and attains a positive numerical value 1.80. This marked change in the value of this parameter thereby clearly indicates a sudden variation in the user's behaviour.

It should be apparent therefore, that by monitoring the magnitude of the residual variances relative to zero within the instantaneous-variance measure table, the profiling application 3 is able to determine which behaviours of the user 4 are changing and when these changes occur. Hence, in accordance with the present invention, in order to determine whether a user's profile and behaviour is changing or evolving, only 3 parameters need be stored for each particular behaviour. Consequently, the size of the user's profile can be significantly reduced, as it is not necessary to store each session log as part of the user profile, since instead the user's profile may be defined by a relatively small number of statistical parameters which are stored in an optimised data structure, which thereby reduces the demands on the mobile device's limited storage capacity.

At the end of a user session, following the calculation of the values in the mean value table, the mean values are then copied to the previous session value table by overwriting the corresponding entries in the previous session value table with the new values. The new values then form a set of ‘initial’ values against which the future entries in the mean value table may be compared during subsequent user sessions.

Returning to FIG. 2, and the example of the web browsing behaviour, it can be seen that the user 4 settles into a stable pattern of behaviour between user sessions 19 to 34, in which the particular web site is viewed 6 times per session. As shown in the final column, the corresponding residual variance values steadily decrease towards zero until such time the numerical value becomes zero (to 2 d.p. as indicated by the lower asterisk in FIG. 2). This therefore clearly highlights the usefulness of this statistical parameter, as not only can it provide an indication of sudden or rapid behavioural change (e.g. as at user session 16), but may also illustrate a steady pattern of behaviour or characteristic activity in the user's usage or mobile device mode of use (e.g. user sessions 19 to 34).

A particularly advantageous feature of the parametric tables 7₁ . . . 7ₙ is their scalability, as multiple users can be added to the tables simply by inserting a new row for each user, as opposed to adding new tables. In this way, the tables 7₁ . . . 7ₙ may scale linearly with the number of users, increasing their size accordingly. This feature is especially useful in applications where there may be more than one user using the mobile device 2, e.g. as in a shared laptop etc. In such multi-user applications, it is preferable that the profiling application 3 provides the user 4 with a logon dialogue box at the start of each user session, which will enable a particular user to commence a user specific session. Thereafter, the user's logon ID would be matched to the corresponding rows in the parametric tables 7₁ . . . 7ₙ of the temporal database 7.

Another advantage of having multi-user data stored within the parametric tables 7₁ . . . 7ₙ is that comparison of different user behaviour is possible by simply comparing corresponding rows of user data. Therefore, it may be possible to infer or deduce some characteristics of a user 4 by comparing the user to the characteristics of a statistically significant sample of other users. Hence, for instance, in the web browsing example, it may be possible to determine the type of web sites that a particular user might be interested in, by checking to see what web sites other users sharing a similar user profile regularly access and view. The whole process of user comparison may therefore be reduced to a simple technique of comparing corresponding numerical values, as opposed to large scale cross-correlation of logged user sessions.

It should be appreciated that for a given number of users and set of monitored behaviours, the parametric tables 7₁ . . . 7ₙ are constant in size, irrespective of whether the number of user sessions increases. This arises from the fact that session logs need not be stored in order to define the user's profile and/or determine any behavioural changes of the user.

In preferred arrangements, the determination of the user's behavioural changes can be used to provide an automatic or adaptive feedback to the user 4 of the mobile device 2. If, for instance, the change in behaviour is related to the user's online shopping habits, such that there has been a marked increase in the amount the user 4 has spent within the last two weeks, the profiling application 3 may provide feedback to the user 4 by way of a cautionary message displayed on the mobile device's output display, e.g. “You seem to have spent quite a lot on shopping recently, don't forget about your savings”. Of course, the message content could be tailored to be specific to any of the monitored behaviours, so if a determined change in behaviour suggests the user 4 has given up on regular exercise (e.g. as assessed by way of biometric monitoring), motivational or encouraging messages could be provided at regular intervals to promote a positive behaviour change.

It is to be appreciated that any such feedback or content could be provided either visually, by way of text, pictures, graphics, video etc., and/or audibly by way of the mobile device's speakers or headphone jack etc.

Returning to the example of the web browsing behaviour, the feedback on the mobile device 2 may be in the form of a dynamic management of the user's web site ‘favourites’ or ‘bookmark list’, such that those web sites found to be of most interest to the user at the present time are conveniently positioned at the most conspicuous location in the list and/or are highlighted in some particular way. Alternatively, or additionally, the feedback may comprise some form of automatic customisation of the mobile device's user interface/operating system etc., e.g. drop-down menus which are tailored to the user's particular behaviours.

Referring again to FIG. 1, there is shown a sensor array 9 associated with the mobile device 2. By ‘associated’ we mean either physically connected by a hardwire link, wirelessly connected by wireless protocols (e.g. Bluetooth, WiFi), physically attached to the mobile device 2 or else forming an integral part of the mobile device 2.

The sensor array 9 preferably contains one or more biometric sensors, including a skin chemical monitoring sensor, a heart rate monitoring sensor and a blood pressure monitor. The use of biometric sensors provides additional information, beyond mode of use, which may be useful in assessing whether the user 4 is undergoing any behavioural changes. Preferably, this additional information is used in conjunction with the interpreted interactions by the definition module 6 to parameterise the user's profile.

It is to be appreciated that any suitable sensor or sensor type may be used in the sensor array 9 associated with the mobile device 2, in accordance with the present invention.

The one or more biometric sensors are able to monitor the user's physiological characteristics while the perform a particular behaviour, such that any changes in chemical constituents of the user's perspiration, heart rate and blood pressure may be detected and linked to that behaviour. Hence, for example, if a user 4 watches soccer on a video stream via his mobile phone, his heart rate may be found to significantly increase, as opposed to those times when he watches golf.

In accordance with the present invention, the profiling application 3 is configured to receive real-time data relating to physical attributes of the user 4, which may then be used in conjunction with the interpreted interactions to determine the user's parameterised profile.

In preferred arrangements, the sensor data from the sensor array 9 is provided to the profiling application 3, where it is then processed using standard algorithms (e.g. facial recognition, voice recognition etc.) as appropriate, before being provided to the definition module 6, where the user profile is defined.

By ‘physical attributes’ we mean physiological and/or any underlying psychological characteristics of an individual, including, but not limited to, health indicators (such as heart rate, blood pressure etc.), voice speech pattern (including intonation, grammar etc.), perspiration content, posture (e.g. head, shoulders) and personality type etc.

In accordance with the present invention, the profiling application 3 may establish a communications session with one or more conventional remote servers, represented generally in FIG. 1 by the remote ‘gateway’ server 10. By ‘gateway’ we mean an Internet gateway server which provides access to the Internet and resources thereof. However, it is to be understood that the server type is in no way intended to be limiting and any suitable server may be used in accordance with the present invention.

In addition to providing access to Internet resources, the server 10 is also suitable for storing ‘back-ups’ (i.e. safe copies) of the parametric tables 7₁ . . . 7ₙ to avoid loss of profile data should the temporal database 7 be lost or corrupted on the mobile device 2. Moreover, the server 10 may also provide a convenient means for downloading updates for the profiling application 3 etc., as and when necessary.

The profiling application 3 is configured to communicate preferably wirelessly or through a hardwired network with the server 10.

A conventional server application 11 manages the communications with the mobile device 2 and maintains a redundant temporal database 12, adapted to receive back-up copies of the parametric tables 7₁ . . . 7ₙ stored on the mobile device 2. The redundant database 12 is preferably substantially the same in form as the temporal database 7, and may be updated regularly or at spaced periodic intervals, e.g. every week etc. The updates may comprise the whole table or one or more rows/entries in the table etc. Advantageously, as the user profiles are parameterised to optimise the storage requirements for the profiles, the transfer of the profiles and updates over a networked connection does not place high demand on available bandwidth, unlike the transfer of user session log data.

Although the present invention is ideally implemented using mobile computing devices it will be recognised that one or more of the principles of the invention could be used in other applications, including any permanently sited devices or appliances where user profiles are determined and stored, e.g. as in some ATM machines, informational kiosks and shopping assistants etc, as well as any devices in which user profile storage capacity is at a premium or where processing power is limited.

Other embodiments are taken to be within the scope of the accompanying claims.

What is claimed is:

1. A method of operating a mobile computing device for interacting with a user and detecting changes in the behaviour of the user, comprising:
monitoring a behaviour of the user by interpreting one or more interactions between the device and the user;
storing information relating to the behaviour of the user in at least a partially parameterised form; and
determining whether the user is exhibiting any changes in behaviour as a function of a variation in one or more parameters within the stored information.

2. The method of claim 1, wherein storing includes storing the information in a temporal database comprising one or more parametric tables to receive the information relating to the behaviour of the user.

3. The method of claim 2, further comprising linearly increasing the size of the one or more parametric tables with an increasing number of users.

4. The method of claim 2, further comprising maintaining a constant size of the one or more parametric tables with an increasing number of user sessions.

5. The method of claim 1, wherein storing includes storing the information in one or more of the following parametric tables: a previous session value table, a mean value table and an instantaneous-variance measure table.

6. The method of claim 1, further comprising updating the stored information with each interaction between the device and the user.

7. The method of claim 1, wherein the storing includes storing the information locally on the device and/or remotely on a gateway server.

8. The method of claim 1, wherein interpreting an interaction involves determining a mode of use of the device.

9. The method of claim 1, wherein interpreting an interaction involves processing a signal received from one or more biometric sensors associated with the device.

10. The method of claim 1, wherein interpreting includes defining, or updating, a user profile for the user based on their behaviour.

11. The method of claim 10, wherein storing the information includes storing the user profile in at least a partially parameterised form.

12. The method of claim 1, wherein determining includes assessing whether a mean and/or variance parameter value has changed relative to a previous value.

13. The method of claim 1, wherein monitoring a behaviour of the user includes:
receiving real-time data relating to physical attributes of the user; and
using the data relating to the physical attributes to interpret one or more interactions between the device and the user.

14. The method of claim 1, further comprising:
establishing a communications session with a remote gateway server;
transmitting to the server the information relating to the behaviour of the user;
and
updating a redundant temporal database within the server, comprising one or more parametric tables, with the transmitted information.

15. The method of claim 1, further comprising presenting to the user a content based on the monitored behaviour of the user and/or the determined behavioural changes of the user.

16. An apparatus comprising:
a mobile computing device for interacting with a user and detecting changes in the behaviour of the user, including:
means for monitoring a behaviour of the user by interpreting one or more interactions between the device and the user;
means for storing information relating to the behaviour of the user in at least a partially parameterised form; and
means for determining whether the user is exhibiting any changes in behaviour as a function of a variation in one or more parameters within the stored information;
and
a remote gateway server for communicating with the mobile computing device, including a redundant temporal database comprising one or more parametric tables for receiving stored information from the mobile computing device.

17. The apparatus of claim 16, wherein the mobile computing device is one of the following devices: a mobile phone, a laptop, a PDA and a tablet PC.

18. A mobile computing device for interacting with a user and for detecting changes in the behaviour of the user, comprising:
means for monitoring a behaviour of the user by interpreting one or more interactions between the device and the user;
means for storing information relating to the behaviour of the user in at least a partially parameterised form; and
means for determining whether the user is exhibiting any changes in behaviour as a function of a variation in one or more parameters within the stored information.

19. The device of claim 18, further comprising one or more biometric sensors for determining physical attributes of the user.

20. A remote gateway server for communicating with a mobile computing device, comprising:
means for receiving from the mobile computing device information relating to the behaviour of the user in at least a partially parameterised form; and
a redundant temporal database comprising one or more parametric tables for receiving the information from the mobile computing device.

21. Apparatus as described substantially herein with reference to the accompanying drawings.
